(19) United States
(12) Patent Application Publication
(10) Pub. No.: US 2024/0253086 A1
(43) Pub. Date: Aug. 1, 2024

(54) PICKLEBALL PADDLE CLEANING DEVICE

(71) Applicant: CRBN Pickleball LLC, Costa Mesa, CA (US)

(72) Inventor: Garrett Gosselin, Costa Mesa, CA (US)

(21) Appl. No.: 18/422,840

(22) Filed: Jan. 25, 2024

Related U.S. Application Data
(60) Provisional application No. 63/481,999, filed on Jan. 27, 2023.

(51) Int. Cl. B08B 1/30; B08B 1/14; C08L 7/00

(52) U.S. Cl. CPC B08B 1/30; B08B 1/14; C08L 7/00

(57) ABSTRACT

A pickleball paddle cleaning device, and related systems, methods, and articles of manufacture are provided.

### RELATED APPLICATIONS

This application claims the benefit of priority to U.S. Provisional Application No. 63/481,999, filed Jan. 27, 2024, the entire contents of which is incorporated herein by reference in its entirety.

### TECHNICAL FIELD

The subject matter described herein relates generally to a cleaning device, and more specifically to a pickleball paddle cleaning device.

### BACKGROUND

Pickleball paddles may include a contact surface made of a variety of materials, including carbon fiber. When a pickleball ball makes contact with the contact surface of the paddle, small fibers of the plastic from the pickleball ball accumulate on the contact surface. Over time, the fibers build up on the contact surface, negatively impacting paddle performance and/or the appearance of the paddle.

### SUMMARY

Systems, methods, and articles of manufacture, are provided for a pickleball paddle cleaning device. The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIGS. 1A and 1B depict an example pickleball paddle cleaning device, consistent with implementations of the current subject matter;

FIG. 2 depicts an example pickleball paddle cleaning device and packaging, consistent with implementations of the current subject matter;

FIG. 3 depicts an example pickleball paddle cleaning device and pickleball paddle, consistent with implementations of the current subject matter;

FIGS. 4A and 4B depict an example pickleball paddle before (left side of paddle) and after (right side of paddle) application of a pickleball paddle cleaning device to the paddle, consistent with implementations of the current subject matter;

FIG. 5 depicts an example pickleball paddle cleaning device packaging, consistent with implementations of the current subject matter; and

FIGS. 6A-6E and 6F-6J depict an example method of applying a pickleball paddle cleaning device to a paddle, consistent with implementations of the current subject matter.

When practical, similar reference numbers denote similar structures, features, or elements.

### DETAILED DESCRIPTION

Pickleball paddles may include a contact surface made of a variety of materials, including carbon fiber, among other materials. In some instances, the contact surface has grooves. For example, the contact surface may have unidirectional grooves that allows the contact surface to impart spin on the ball.

When a pickleball ball makes contact with the contact surface of the paddle, small fibers of the plastic from the pickleball ball, dirt, dust, and/or other particles accumulate on the contact surface, such as within the grooves. Over time, the fibers build up on the contact surface, negatively impacting paddle performance and/or the appearance of the paddle. For example, the buildup of the fibers on the contact surface may reduce an amount of spin that can be generated during use. Generally, a cloth or towel may be used to wipe the contact surface of the pickleball paddle. However, cloths or towels may not sufficiently clean the contact surface, such as within the grooves. Cloths or towels may additionally and/or alternatively fail to adequately restore the appearance of the contact surface. It should be understood that while the disclosure herein focuses on pickleball paddles or rackets, the cleaning device and methods could apply to other types of articles that need to be cleaned or that need to have residue removed from its surface. E.g., other types of rackets or paddles, golf clubs, bats, and the like.

Consistent with implementations of the current subject matter, the pickleball paddle cleaning device is specifically made to easily and effectively clean the contact surface of the pickleball paddle.

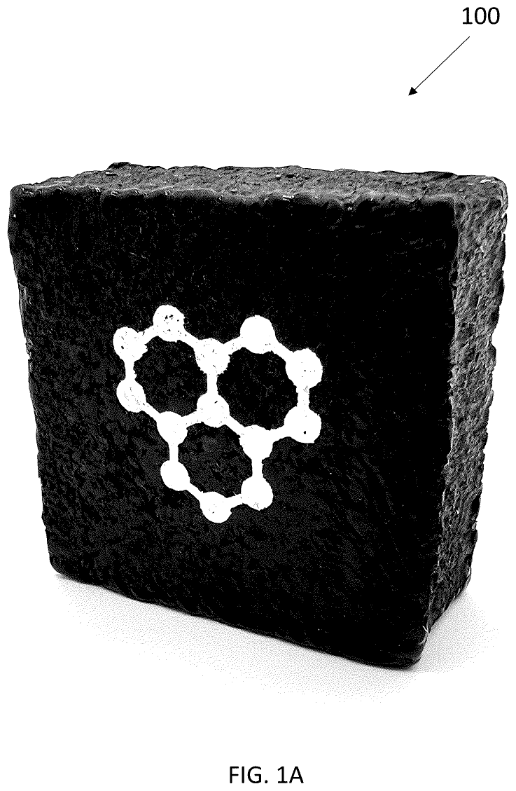

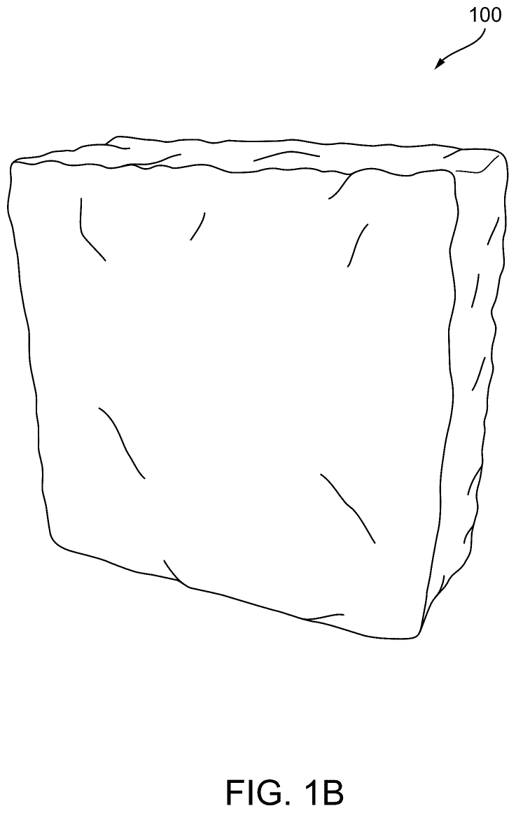

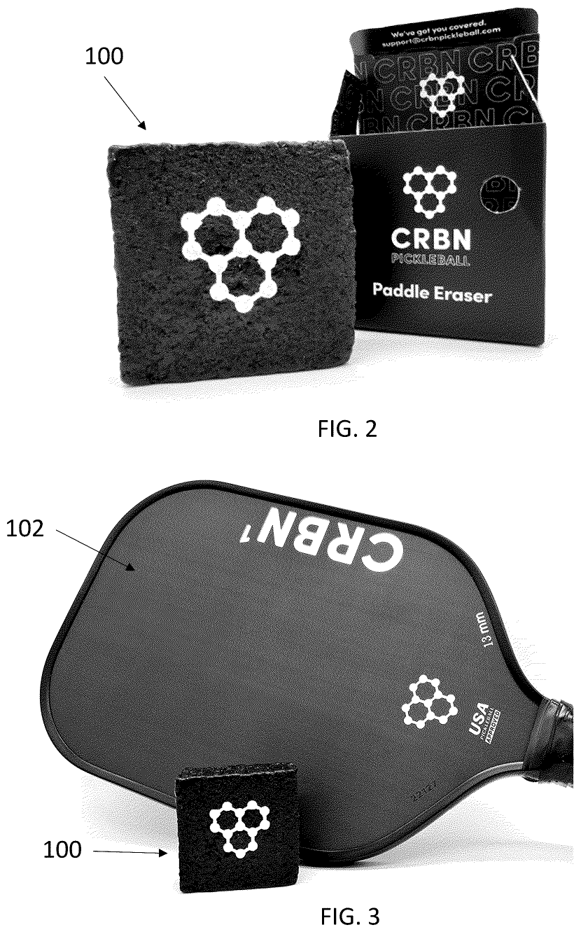

FIGS. 1A-5 illustrate an example of a pickleball paddle cleaning device 100, a pickleball paddle 102 (e.g., a pickleball paddle including a carbon or carbon fiber contact surface, with grooves, and/or the like), and packaging 104 for the pickleball cleaning device 100 (PADDLE ERASER™, CRBN PICKLEBALL LLC), consistent with implementations of the current subject matter. The pickleball paddle cleaning device 100 may be made of rubber, such as soft rubber, natural rubber, synthetic rubber, a blend of rubber, rubber polymers, other polymers, mixtures thereof, and/or the like. Rubber is an elastic substance obtained from the exudations of certain tropical plants (natural rubber) or derived from petroleum and natural gas (synthetic rubber). In embodiments, rubber comprises a polyisoprene, a neoprene, Styrene-butadiene or styrene-butadiene rubber (SBR), and/or a nitrile rubber. In embodiments the rubber can include a silicone rubber, for example. In embodiments the rubber can include one or more of a fluoro rubber such as FKM/Viton, for example, EPDM rubber and butyl rubber. Also, in embodiments the rubber can include a thermoplastic elastomer/rubber (TPE/TPR). The rubber can be, for example, a vulcanized rubber. One or more of the rubbers can have one or more of the properties or characteristics described herein.

The material of the pickleball paddle cleaning device 100 may be designed to quickly remove ball residue, dirt, and/or scrapes, scratches, and scuffs from the contact surface of the pickleball paddle 102. In some implementations, the material of the pickleball paddle cleaning device 100 is designed specifically for cleaning ball fibers off the surface of any carbon-faced paddle (e.g., a pickleball paddle or other paddle including a contact surface at least partially made of carbon or carbon fiber material). For example, the material of the pickleball paddle cleaning device 100 is designed to pull out and/or rub off dirt and grime off a gritty surface, such as the contact surface of the pickleball paddle 102. Additionally and/or alternatively, the pickleball cleaning device 100 can be designed to have specifications and/or a material that is suitable for cleaning rackets and/or paddles, such as the paddle 102, without significantly harming (in other words, minimal or no harm) the surface or finish of the paddles. Such specifications and/or material includes hardness, porosity, grit, abrasiveness, etc., suitable for removing debris from the surface (e.g., the contact surface of the paddle 102) to be cleaned without significantly damaging or to limit or prevent damage to the surface (e.g., scuffing, scratching, etc.).

In some implementations, the pickleball paddle cleaning device 100 prevents or limits current or future buildup of debris, such as pickleball ball fibers, on at least the contact surface of the pickleball paddle 102. For example, consistent use of the pickleball paddle cleaning device 100 prevents or limits extensive buildup of ball fibers and keeps the paddle 102 as gritty as possible to improve performance. The pickleball paddle cleaning device 100 additionally and/or alternatively erases ball residue and minor scratches, as noted herein.

As noted above, the pickleball paddle cleaning device 100 may improve performance of the pickleball paddle 102, such as after application of the pickleball paddle cleaning device 100 to the paddle 102. For example, application of the pickleball paddle cleaning device 100 to the paddle 102 may improve and/or maximize grit potential of at least the contact surface of the paddle 102. For example, during use (e.g., contact between the paddle 102 and a pickleball ball), small fibers of the plastic from the pickleball ball accumulate on the surface of the paddle 102, such as within the grooves of the contact surface of the paddle 102. This clogs the grooves, diminishing the ability to apply spin to the ball. The pickleball paddle cleaning device 100 helps to remove debris from the grooves and/or other portion of the contact surface to retain and/or regain the ability to apply spin to the pickleball ball when the ball contacts the contact surface in use.

Additionally and/or alternatively, the pickleball paddle cleaning device 100 improves the appearance of the paddle 102, such as the contact surface of the paddle. For example, removal of the debris from the contact surface of the paddle, such as via application of the pickleball cleaning device 100 to the contact surface of the paddle 102 cleans the contact surface. This provides an improved appearance to the paddle 102.

Additionally and/or alternatively, the pickleball paddle cleaning device 100 is ergonomically shaped and/or sized and provides an improved user experience. For example, the size and/or shape makes it easy to make a few quick swipes and leave the paddle looking new. The cleaning device 100 is also sized and/or shaped to be easily gripped and/or manipulated, to fit in an equipment bag, and/or the like, while still improving cleaning performance. In some implementations, the pickleball paddle cleaning device 100 has a rectangular shape, although other shapes are contemplated. For example, a height of the pickleball paddle cleaning device 100 may be approximately 2 inches, a width of the pickleball paddle cleaning device 100 may be approximately 2 inches, and a depth of the pickleball paddle cleaning device 100 may be approximately 1 inch. Additionally and/or alternatively, the pickleball paddle cleaning device 100 may have a height of approximately 1.5 to 2.5 inches, 1 to 3 inches, and/or the like, a width of approximately 1.5 to 2.5 inches, 1 to 3 inches, and/or the like, and a depth of approximately 0.5 to 1.5 inches, 0.25 to 1.75 inches, and/or the like. In some implementations, the cleaning device 100 has a height of approximately 1 to 4 inches. In some implementations, the cleaning device 100 has a height of approximately 1 to 3 inches. In some implementations, the cleaning device 100 has a height of approximately 1.5 to 3 inches. In some implementations, the cleaning device 100 has a width of approximately 1 to 4 inches. In some implementations, the cleaning device 100 has a width of approximately 1 to 3 inches. In some implementations, the cleaning device 100 has a width of approximately 1.5 to 3 inches. In some implementations, the cleaning device 100 has a depth of approximately 0.25 to 1.75 inches. In some implementations, the cleaning device 100 has a net weight of approximately 1.5 oz. in other implementations, the cleaning device 100 has a net weight of approximately 1 to 2 oz.

In some implementations, the cleaning device 100 is convenient and long-lasting. For example, the cleaning device provides an improved experience, such as in comparison to a liquid cleaning solution. The cleaning device 100 may additionally and/or alternatively be used to clean the paddle 102 before, after, and/or during games (e.g., in use) and may provide improved performance for an extended duration.

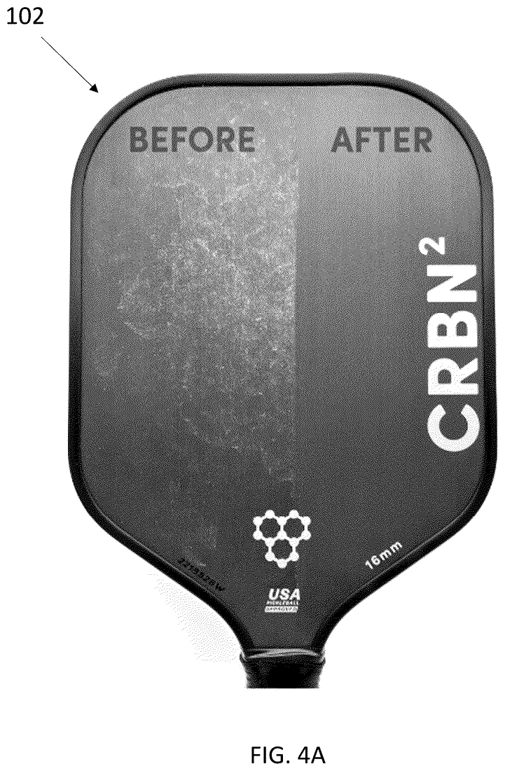

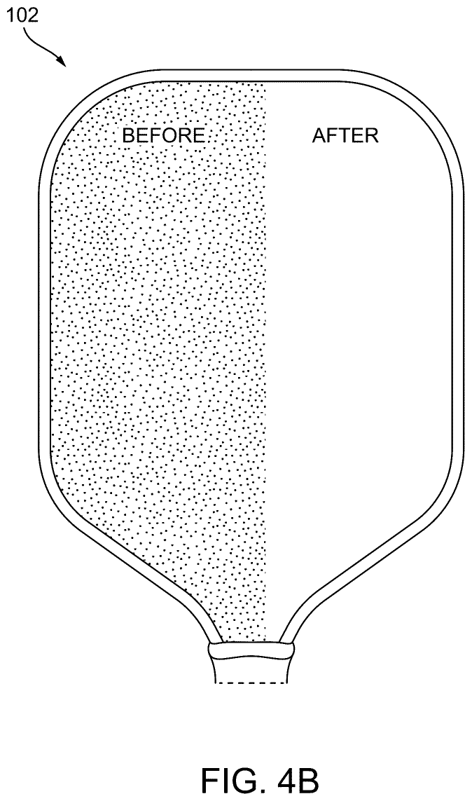

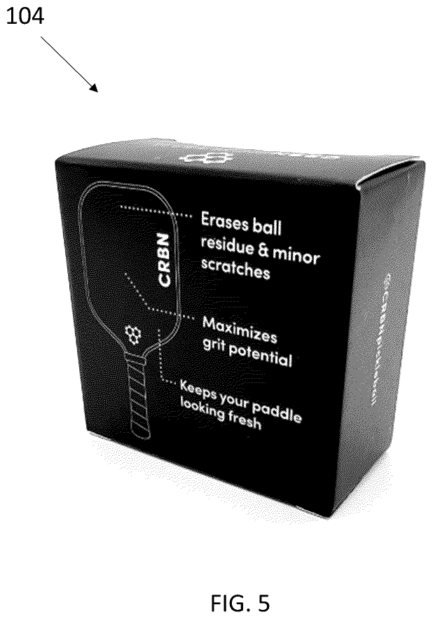

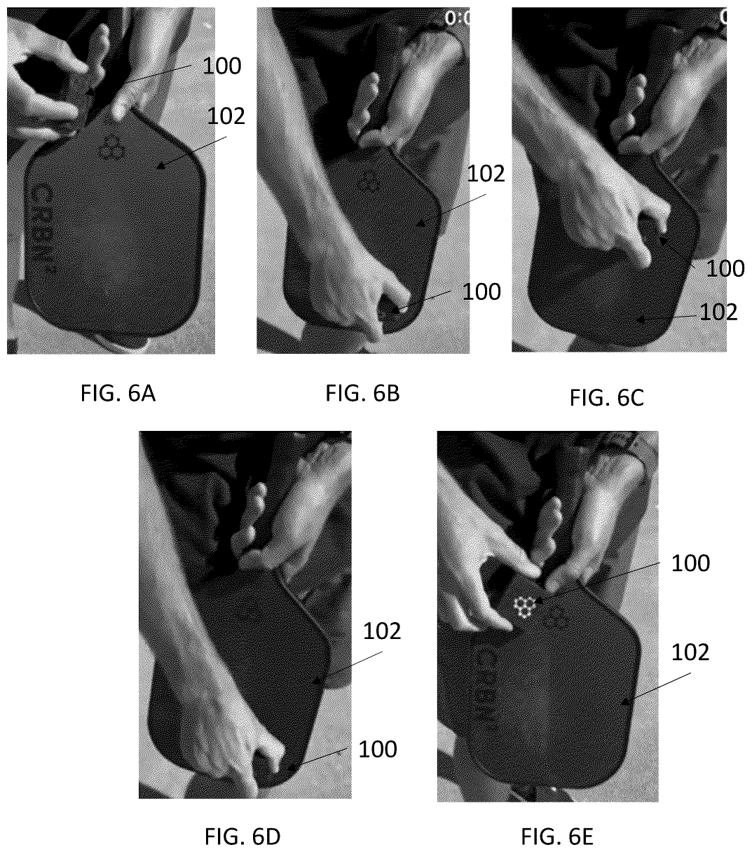

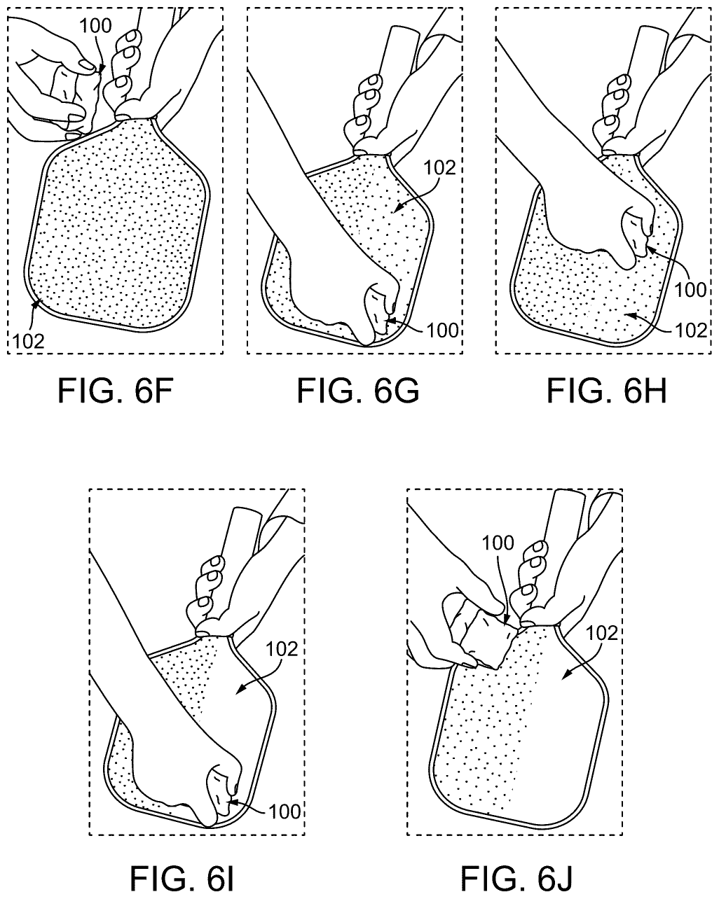

FIGS. 6A-6E and 6F-6J illustrate an example method of cleaning the paddle 102 (e.g., the contact surface of the paddle 102) with the pickleball paddle cleaning device 100, consistent with implementations of the current subject matter. As shown, the paddle 102 can be cleaned by, for example, rubbing the cleaning device up and down the face (e.g., contact surface) of the paddle 102. In some implementations, the cleaning device 100 cleans the surface of the paddle 102 in less than 3 strokes, less than 5 strokes, less than 7 strokes, and/or the like. For example, FIG. 4 illustrates an example of the paddle 102 before (on the left) and after (on the right) application of the cleaning device 100 to the paddle 102 (e.g., the contact surface of the paddle 102). Accordingly, the cleaning device 100 may easily and efficiently remove residue, dirt, and/or scuffs and scratches.

In embodiments, the cleaning device has a tensile strength between about 0.5 mega Pascals (MPa) and about 2.5 MPa. In embodiments, the cleaning device has a tensile strength between about 1 mega Pascals (MPa) and about 2.5 MPa. In embodiments, the cleaning device has a tensile strength between about 1.5 mega Pascals (MPa) and about 2.5 MPa. In embodiments, the cleaning device has a tensile strength between about 1.5 mega Pascals (MPa) and about 2.0 MPa. In embodiments, the cleaning device has a tensile strength between about 1.5 mega Pascals (MPa) and about 1.9 MPa. In embodiments, the cleaning device has a tensile strength between about 1.5 mega Pascals (MPa) and about 1.8 MPa. In embodiments, the cleaning device has a tensile strength between about 1.6 mega Pascals (MPa) and about 2.0 MPa. In embodiments, the cleaning device has a tensile strength between about 1.7 mega Pascals (MPa) and about 2.0 MPa. In embodiments, the cleaning device has a tensile strength between about 0.5 mega Pascals (MPa) and about 2.25 MPa. In embodiments, the cleaning device has a tensile strength between about 0.5 mega Pascals (MPa) and about 2.0 MPa. In embodiments, the cleaning device has a tensile strength between about 1 mega Pascals (MPa) and about 2 MPa. In embodiments, the cleaning device has a tensile strength between about 1 mega Pascals (MPa) and about 1.9 MPa. In embodiments, the cleaning device has a tensile strength between about 1 mega Pascals (MPa) and about 1.8 MPa. In embodiments, the cleaning device has a tensile strength between about 1.7 mega Pascals (MPa) and about 1.9 MPa. In embodiments, the cleaning device has a tensile strength between about 1.7 mega Pascals (MPa) and about 1.8 MPa. The tensile strength may be any value or subrange within the recited ranges, including endpoints.

In embodiments, the cleaning device has a tensile strength of about 0.5 MPa. In embodiments, the cleaning device has a tensile strength of about 0.75 MPa. In embodiments, the cleaning device has a tensile strength of about 1 MPa. In embodiments, the cleaning device has a tensile strength of about 1.1 MPa. In embodiments, the cleaning device has a tensile strength of about 1.2 MPa. In embodiments, the cleaning device has a tensile strength of about 1.3 MPa. In embodiments, the cleaning device has a tensile strength of about 1.4 MPa. In embodiments, the cleaning device has a tensile strength of about 1.5 MPa. In embodiments, the cleaning device has a tensile strength of about 1.6 MPa. In embodiments, the cleaning device has a tensile strength of about 1.7 MPa. In embodiments, the cleaning device has a tensile strength of about 1.77 MPa. In embodiments, the cleaning device has a tensile strength of about 1.8 MPa. In embodiments, the cleaning device has a tensile strength of about 1.9 MPa. In embodiments, the cleaning device has a tensile strength of about 2.0 MPa. In embodiments, the cleaning device has a tensile strength of about 2.1 MPa. In embodiments, the cleaning device has a tensile strength of about 2.2 MPa. In embodiments, the cleaning device has a tensile strength of about 2.3 MPa. In embodiments, the cleaning device has a tensile strength of about 2.4 MPa. In embodiments, the cleaning device has a tensile strength of about 2.5 MPa.

In embodiments, the cleaning device has an elongation at break of about 120% to about 160%. In embodiments, the cleaning device has an elongation at break of about 130% to about 160%. In embodiments, the cleaning device has an elongation at break of about 140% to about 160%. In embodiments, the cleaning device has an elongation at break of about 150% to about 160%. In embodiments, the cleaning device has an elongation at break of about 120% to about 150%. In embodiments, the cleaning device has an elongation at break of about 120% to about 140%. In embodiments, the cleaning device has an elongation at break of about 120% to about 130%. The elongation at break may be any value or subrange within the recited ranges, including endpoints.

In embodiments, the cleaning device has an elongation at break of about 120%. In embodiments, the cleaning device has an elongation at break of about 130%. In embodiments, the cleaning device has an elongation at break of about 135%. In embodiments, the cleaning device has an elongation at break of about 140%. In embodiments, the cleaning device has an elongation at break of about 145%. In embodiments, the cleaning device has an elongation at break of about 150%. In embodiments, the cleaning device has an elongation at break of about 160%.

In embodiments, the cleaning device has a shore A hardness value of about 30 to about 40. In embodiments, the cleaning device has a shore A hardness value of about 30 to about 40 after 1 second. In embodiments, the cleaning device has a shore A hardness value of about 30 to about 39. In embodiments, the cleaning device has a shore A hardness value of about 30 to about 38. In embodiments, the cleaning device has a shore A hardness value of about 30 to about 37. In embodiments, the cleaning device has a shore A hardness value of about 30 to about 36. In embodiments, the cleaning device has a shore A hardness value of about 30 to about 35. In embodiments, the cleaning device has a shore A hardness value of about 30 to about 34. In embodiments, the cleaning device has a shore A hardness value of about 30 to about 33. In embodiments, the cleaning device has a shore A hardness value of about 31 to about 40. In embodiments, the cleaning device has a shore A hardness value of about 32 to about 40. In embodiments, the cleaning device has a shore A hardness value of about 33 to about 40. In embodiments, the cleaning device has a shore A hardness value of about 34 to about 40. In embodiments, the cleaning device has a shore A hardness value of about 32 to about 38. In embodiments, the cleaning device has a shore A hardness value of about 33 to about 37. The hardness value may be any value or subrange within the recited ranges, including endpoints.

In embodiments, the cleaning device has a shore A hardness value of about 30. In embodiments, the cleaning device has a shore A hardness value of about 31. In embodiments, the cleaning device has a shore A hardness value of about 32. In embodiments, the cleaning device has a shore A hardness value of about 33. In embodiments, the cleaning device has a shore A hardness value of about 34. In embodiments, the cleaning device has a shore A hardness value of about 35. In embodiments, the cleaning device has a shore A hardness value of about 36. In embodiments, the cleaning device has a shore A hardness value of about 37. In embodiments, the cleaning device has a shore A hardness value of about 38. In embodiments, the cleaning device has a shore A hardness value of about 39. In embodiments, the cleaning device has a shore A hardness value of about 40.

In embodiments, the cleaning device has a density of about 0.5 g/cm³ to about 2.0 g/cm³. In embodiments, the cleaning device has a density of about 0.6 g/cm³ to about 2.0 g/cm³. In embodiments, the cleaning device has a density of about 0.7 g/cm³ to about 2.0 g/cm³. In embodiments, the cleaning device has a density of about 0.8 g/cm³ to about 2.0 g/cm³. In embodiments, the cleaning device has a density of about 0.9 g/cm³ to about 2.0 g/cm³. In embodiments, the cleaning device has a density of about 1.0 g/cm³ to about 2.0 g/cm³. In embodiments, the cleaning device has a density of about 1.1 g/cm³ to about 2.0 g/cm³. In embodiments, the cleaning device has a density of about 1.2 g/cm³ to about 2.0 g/cm³. In embodiments, the cleaning device has a density of about 1.5 g/cm³ to about 2.0 g/cm³. In embodiments, the cleaning device has a density of about 0.5 g/cm³ to about 1.8 g/cm³. In embodiments, the cleaning device has a density of about 0.5 g/cm³ to about 1.6 g/cm³. In embodiments, the cleaning device has a density of about 0.5 g/cm³ to about 1.4 g/cm³. In embodiments, the cleaning device has a density of about 0.5 g/cm³ to about 1.2 g/cm³. In embodiments, the cleaning device has a density of about 0.5 g/cm³ to about 1.1 g/cm³. In embodiments, the cleaning device has a density of about 0.5 g/cm³ to about 1.0 g/cm³. In embodiments, the cleaning device has a density of about 0.5 g/cm³ to about 0.9 g/cm³. In embodiments, the cleaning device has a density of about 0.6 g/cm³ to about 1.5 g/cm³. In embodiments, the cleaning device has a density of about 0.6 g/cm³ to about 1.2 g/cm³. In embodiments, the cleaning device has a density of about 0.6 g/cm³ to about 1.0 g/cm³. In embodiments, the cleaning device has a density of about 0.7 g/cm³ to about 1.5 g/cm³. In embodiments, the cleaning device has a density of about 0.7 g/cm³ to about 1.2 g/cm³. In embodiments, the cleaning device has a density of about 0.7 g/cm³ to about 1.0 g/cm³. In embodiments, the cleaning device has a density of about 0.7 g/cm³ to about 0.9 g/cm³. In embodiments, the cleaning device has a density of about 0.8 g/cm³ to about 1.0 g/cm³. In embodiments, the cleaning device has a density of about 0.8 g/cm³ to about 0.9 g/cm³. The density may be any value or subrange within the recited ranges, including endpoints.

In embodiments, the cleaning device has a density of about 0.5 g/cm³. In embodiments, the cleaning device has a density of about 0.6 g/cm³. In embodiments, the cleaning device has a density of about 0.7 g/cm³. In embodiments, the cleaning device has a density of about 0.8 g/cm³. In embodiments, the cleaning device has a density of about 0.9 g/cm³. In embodiments, the cleaning device has a density of about 1.0 g/cm³. In embodiments, the cleaning device has a density of about 1.1 g/cm³. In embodiments, the cleaning device has a density of about 1.2 g/cm³. In embodiments, the cleaning device has a density of about 1.3 g/cm³. In embodiments, the cleaning device has a density of about 1.4 g/cm³. In embodiments, the cleaning device has a density of about 1.6 g/cm³. In embodiments, the cleaning device has a density of about 1.8 g/cm³. In embodiments, the cleaning device has a density of about 2.0 g/cm³.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. References to a structure or feature that is disposed “adjacent” another feature may have portions that overlap or underlie the adjacent feature.

Spatially relative terms, such as, for example, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

As used herein in the specification and claims, including as used in the examples and unless otherwise expressly specified, all numbers may be read as if prefaced by the word “about” or “approximately,” even if the term does not expressly appear. The phrase “about” “or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, in some implementations, the phrase “approximately” may include +/−0.03 mm, +/−0.05 mm, or the like.

### Example

Tensile strength, elongation, hardness, and density of an exemplary pickleball paddle cleaning device was tested. The tested cleaning device was made of natural rubber.

### Tensile Test

A sheet of test material was tested with reference to ASTM D412-16(2021) Method A. Test specimens were cut from the sample sheet. Specimen: Die C; Specimen Thickness: 3.12 mm (for reference only due to uneven specimen surface); testing speed: 500 mm/min; Gauge length: 25 mm; Lab environmental condition: (23±2) ° C., (50±5)% relative humidity (RH). Testing was performed with a Universal Testing Machine (Model: CMT6103).

TABLE 1
Tensile Test Results

| Test Item | Test Result |
|---|---|
| Tensile Strength | 1.77 MPa |
| Elongation at Break | 140% |

### Shore Hardness

A sheet of test material was tested with reference to ASTM D2240-15(2021). Test specimens were cut from the sample sheet. Specimen thickness: 6.38 mm (2 layers oiled up); Lab environmental condition: (23±2) ° C., (50±5)% RH. Testing was performed on a Multifunction Hardness Tester (Model: Digitest II).

Shore hardness result: A/34/1 (A/X/1 indicates that A is the type of durometer, X is the hardness value, 1 second (s) is the reading time.

### Density

A sheet of test material was tested with reference to ASTM D792-20 Method A. Test specimens were cut from the sample sheet. Test condition included deionized water (23±2° ° C.); Lab environmental condition: (23±2)° ° C., (50±5)% RH. Testing was performed on an Electron Balance (Model: XPE204).

Density was measured at 0.899 grams per cubic centimeter (g/cm³).

What is claimed is:

1. A pickleball paddle cleaning device comprising one or more of the following:
(a) a tensile strength between about 0.5 mega Pascals (MPa) and about 2.5 MPa;
(b) an elongation at break of about 120% to about 160%;
(c) a shore A hardness value of about 30 to about 40; and
(d) a density of about 0.5 g/cm³ to about 2.0 g/cm³.

2. The pickleball paddle cleaning device of claim 1, having two or more of (a), (b), (c), and (d).

3. The pickleball paddle cleaning device of claim 1, having three or more of (a), (b), (c), and (d).

4. The pickleball paddle cleaning device of claim 1, having (a), (b), (c), and (d).

5. The pickleball paddle cleaning device of claim 1, having a tensile strength between about 1.5 MPa and about 1.9 MPa, an elongation at break of about 130% to about 150%, a shore A hardness value of about 32 to about 36, and a density of about 0.7 to about 1.0 g/cm³.

6. The pickleball paddle cleaning device of claim 1, having a height of about 1.5 inches to about 4 inches, a width of about 1.5 inches to about 4 inches, and a depth of about 0.5 inches to 1.5 inches.

7. The pickleball paddle cleaning device of claim 1, wherein the cleaning device comprises, consists essentially of, or consists of a rubber, rubber polymer, other polymer, or a mixture thereof.

8. The pickleball paddle cleaning device of claim 7, wherein the rubber comprises, consists essentially of, or consists of a soft rubber, natural rubber, synthetic rubber, or a blend of rubber.

9. A method of applying and/or manufacturing a pickleball paddle cleaning device of claim 1.

10. A product comprising a pickle ball paddle cleaning device of claim 1 and instructions for use and/or packaging.

11. A system comprising a pickleball paddle cleaning device of claim 1, a pickleball paddle, and/or packaging for a pickleball cleaning device.

12. A method of cleaning a surface of a pickleball paddle, comprising contacting a surface of a paddle with a cleaning device of claim 1, and moving the cleaning device on the surface while applying contact force between the cleaning device and the surface for a period of time sufficient to remove debris from the surface.

13. A method of cleaning a surface of a pickleball paddle, comprising contacting a surface of a paddle with a cleaning device comprising, consisting essentially of, or consisting of a rubber, rubber polymer, other polymer, or a mixture thereof, and moving the cleaning device on the surface while applying contact force between the cleaning device and the surface for a period of time sufficient to remove debris from the surface.

14. The method of claim 13, wherein the rubber comprises, consists essentially of, or consists of a soft rubber, natural rubber, synthetic rubber, or a blend of rubber.

15. The method of claim 13, the cleaning device having a height of about 1.5 inches to about 4 inches, a width of about 1.5 inches to about 4 inches, and a depth of about 0.5 inches to 1.5 inches.
